(19) United States
(12) Patent Application Publication
(10) Pub. No.: US 2016/0212931 A1
(43) Pub. Date: Jul. 28, 2016

(54) AGRICULTURAL SEEDING AND HARVESTING SYSTEM

(71) Applicant: Jeremy C. Henry, Connersville, IN (US)

(72) Inventor: Jeremy C. Henry, Connersville, IN (US)

(21) Appl. No.: 15/008,979

(22) Filed: Jan. 28, 2016

Related U.S. Application Data
(60) Provisional application No. 62/108,583, filed on Jan. 28, 2015.

(51) Int. Cl. A01C 7/08; G01F 11/00

(52) U.S. Cl. CPC A01C 7/085; G01F 11/003

(57) ABSTRACT

An agricultural harvester including a chassis, a header coupled to the chassis and a seeding system. The seeding system is coupled to the chassis or the header, and the seeding system is configured to broadcast seed onto the ground as the harvester traverses the ground.

### CROSS REFERENCE TO RELATED APPLICATIONS

This is a non-provisional application based upon U.S. provisional patent application Ser. No. 62/108,583, entitled “AGRICULTURAL SEEDER COUPLED TO AN AGRICULTURAL HARVESTER”, filed Jan. 28, 2015, which is incorporated herein by reference.

### BACKGROUND OF THE INVENTION

1. Field of the Invention

The present invention relates to agricultural harvesters, and, more particularly, to agricultural combines.

2. Description of the Related Art

Farmers utilize a wide variety of harvesting machines for various crops. A versatile harvester is exemplified in the form of a combine, which can be reconfigured with different headers and/or adjustments to accommodate different crops. A grain harvesting combine includes a header, which cuts the crop and feeds it into a threshing rotor. The threshing rotor rotates within a perforated housing, performing a threshing operation of the grain from the crop directed thereinto. Once the grain is threshed it falls through perforations in the housing onto a grain pan. From the grain pan the grain falls through a set of upper and lower sieves that are known as the cleaning shoe. The sieves are vibrating or oscillating causing clean grain to fall through for the purposes of collection of the grain and the removal of the chaff or other debris. The cleaning fan blows air through the sieves to discharge chaff toward the rear of the combine. Crop residue such as straw from the threshing section proceeds through a straw chopper and out the rear of the combine.

The material other than grain (MOG) is distributed on the field, either in a generally uniform fashion to cover the ground and to decompose or in a windrow fashion so that the MOG can be separately gathered. Once the crop is harvested, often a cover crop is planted. The cover crop is a crop planted primarily to manage soil erosion, soil fertility, soil quality, water, weeds, pests, diseases, and for promoting biodiversity and wildlife health in the ecosystem and/or to produce food, feed, or fiber.

Cover crops are used as part of sustainable agriculture as many of them improve the sustainability of the agricultural system attributes and may also indirectly improve qualities of neighboring natural ecosystems. Farmers choose to grow and manage specific cover crop types based on their own needs and goals, influenced by the biological, environmental, social, cultural, and economic factors.

One of the primary uses of cover crops is to increase soil fertility and are often referred to as “green manure.” The cover crop is used to manage the soil macronutrients and micronutrients. Of the various nutrients impacted, the influence that cover crops have on nitrogen management has received the most attention, because nitrogen is often the most limiting nutrient in crop production. Generally, the green manure crops are grown, and then plowed under before reaching full maturity in order to improve soil fertility and quality.

Often the selection of the green manure crops are leguminous, meaning they are part of the pea family. Leguminous cover crops are typically high in nitrogen and can often provide the required quantity of nitrogen for crop production. In conventional farming, chemical nitrogen is typically applied in a fertilizer form, but the use of cover crops functions as a fertilizer replacement. Other seed types, such as beets and grasses or combinations can be used as cover crops.

The cover crop seeding is a separate operation carried out after the harvesting process, and is often done using a seed broadcasting method.

What is needed in the art is a way of seeding the field in a more efficient manner.

### SUMMARY OF THE INVENTION

The present invention provides a seeding function associated with a harvester.

The invention in one form is directed to an agricultural harvester including a chassis, a header coupled to the chassis and a seeding system. The seeding system is coupled to the chassis or the header, and the seeding system is configured to broadcast seed onto the ground as the harvester traverses the ground.

The invention in another form is directed to a seeding system for use in conjunction with an agricultural harvester. The seeding system is coupled to a header. The seeding system is configured to broadcast seed onto the ground as the harvester traverses the ground.

The invention in yet another form is directed to a method of seeding a cover crop, including the steps of cutting a crop using an agricultural harvester; and distributing seed from a seed tank coupled to the agricultural harvester onto the ground.

An advantage of the present invention is that the seeding of a cover crop takes place at the time of harvesting.

Another advantage of the present invention is that the cover crop is broadcast on the ground with the MOG from the harvesting operation put on top of the seed layer.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an embodiment of an agricultural harvester having a seeding system of the present invention;

FIG. 2 is a perspective view of part of the seeding system of FIG. 1 shown looking at the back of a detached small grain header of the harvester of FIG. 1;

FIG. 3 is a closer perspective view of the seeder of FIG. 2;

FIG. 4 is an even closer perspective view of a portion of the seeder of FIGS. 1-3;

FIG. 5 is a perspective view of part of a seed metering device of the seeder of FIGS. 1-3 showing a sprocket in schematic form used to drive an auger in the seed box;

FIG. 6 is a perspective view of another part of the seed metering device of the seeder of FIGS. 1-3;

FIG. 7 is a perspective view of a ground speed detector used by the metering device of FIGS. 5 and 6 as part of the metering of the seeds applied to the ground; and

FIG. 8 is a functional diagram depicting elements of the seeding system of the present invention.

Corresponding reference characters indicate corresponding parts throughout the several views. The exemplifications set out herein illustrate some embodiments of the invention and such exemplifications are not to be construed as limiting the scope of the invention in any manner.

### DETAILED DESCRIPTION OF THE INVENTION

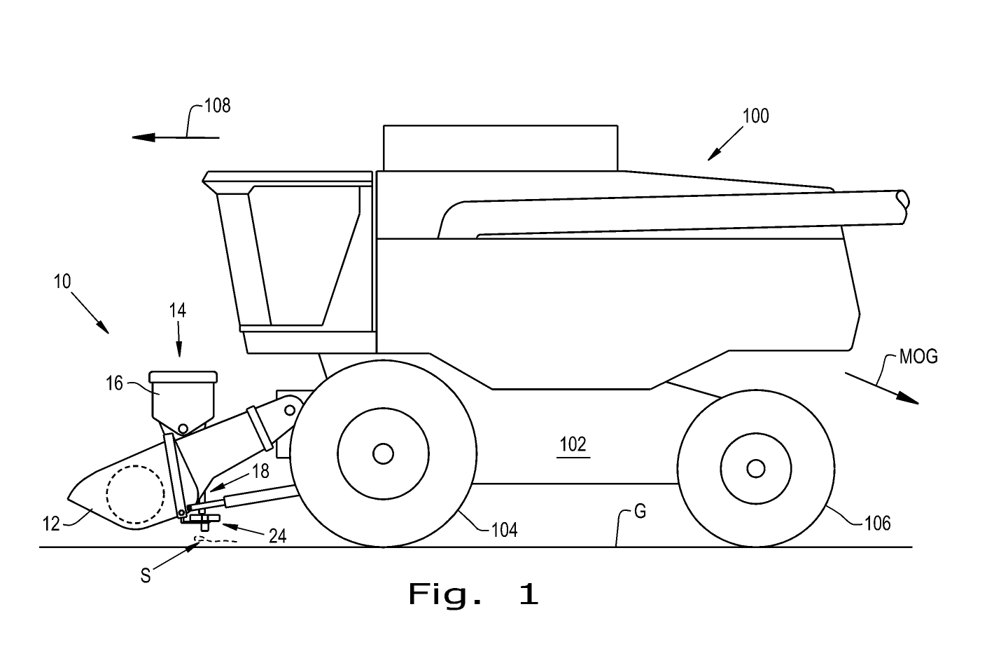

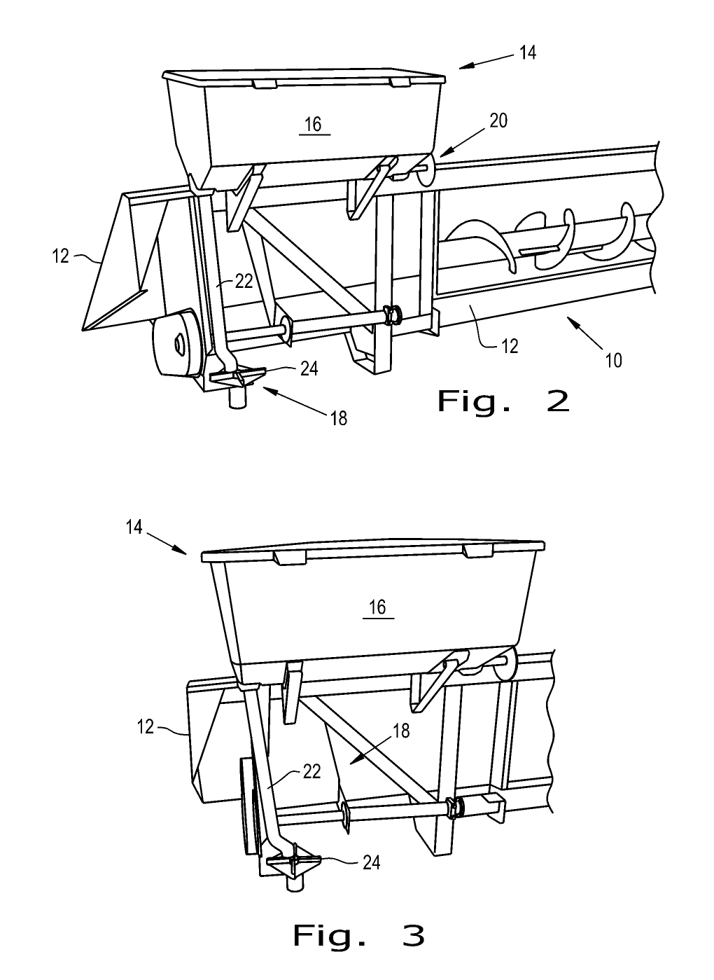

Referring now to the drawings, and more particularly to FIGS. 1-3, there is shown a harvesting header/seeder system 10 that includes a harvesting header 12 and a seeder system 14. Seeder system 14 includes seed boxes 16, a distribution system 18, and a seed metering system 20. As a harvesting operation takes place with header 12 in association with a combine 100 ground cover seed is metered from seed boxes 16 by way of metering system 20, so that the seed is then seeded onto the ground by distribution system 18.

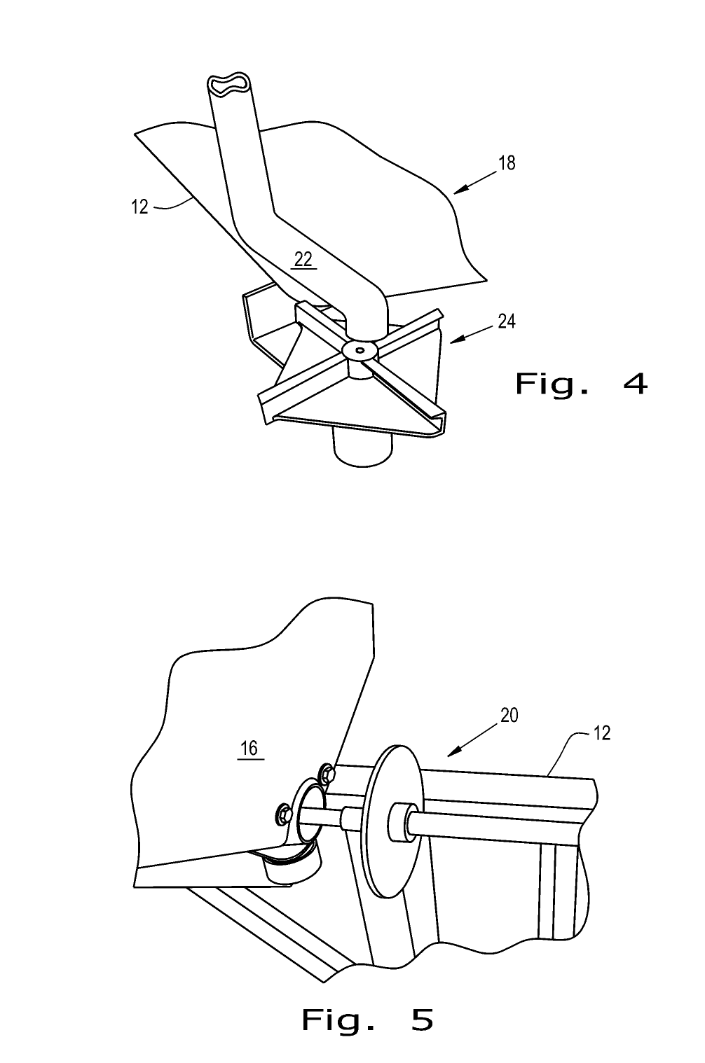

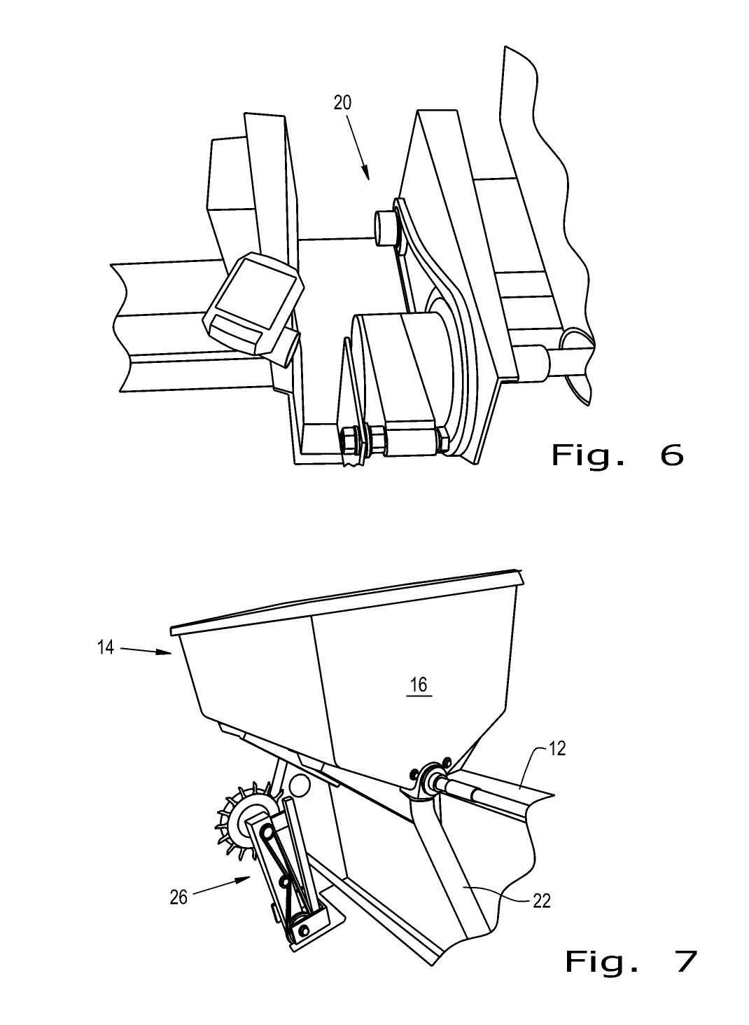

Now, additionally referring to FIG. 4-7 there are illustrated, in closer detail, some elements of system 10. Distribution system 18 includes tubing 22 and a fan 24. As seed is metered form boxes 16 it is directed by way of tubes 22 to fan 24, which is driven to throw the seed in a relatively uniform distribution on the ground. Several seed boxes 16 and distribution systems 18 may be utilized with each header 12. It is generally thought that at lease one seed box 16, which can also be considered a grain tank 16, will be positioned on each side of header 12, with just one side of header 12 being shown in the figures for the sake of clarity.

Now additionally referring to FIG. 7, there is shown a ground speed detector 26 that is moved (or pivoted counter clockwise from the position shown) to contact the ground when header 12 is in a lowered harvesting position. Information in the form of a signal from speed detector 26 is used by metering system 20 to control the rate of seed distribution from boxes 16. It is also contemplated to use harvesting speed information from the combine data/control system, such as that which may be available on a CAN bus or from a control unit on the combine.

The cover crop seeder systems 14 attach to a corn and/or bean head 12 to seed cover crops while combining. One reason for the present invention is to eliminate an extra trip across the field with another piece of equipment to seed the cover crop. Another reason for the use of the present invention is to avoid having to hire an airplane to seed the ground with the expense of the airplane being as much as the seed cost itself. Yet another reason is that the seed is advantageously put on the ground prior to the MOG being distributed, thereby putting organic material over the top of the seed to assist germination and moisture retention.

In using a corn head, it may, for example, use two corn planter dry fertilizer boxes 16 as seed boxes 16 one on each end of the corn header attached to the back top rail of the corn head. These boxes 16 hold enough seed to do 14 acres to 20 acres between fill ups depending on the cover crop that is seeded. The seed boxes 16 have augers in the bottom to auger out seed at a desired rate per acre by way of metering system 20. Then seed is dropped through PVC pipe 22 to fans 24, which may be powered by 12-volt motors, causing the seed to be spread behind the corn head and in front and around the front tires 104 of the combine 100 and under the feeder house. There is a fan 24 and motor on each side of the head to spread the seed. The seeder 14 may be driven off of the combine reel speed hydraulics, with supply and return hoses to hook and unhook when taking off the head that feeds a hydraulic motor to drive the seeder augers.

Most modern combines have auto reel speed so that when the combine ground speed gets faster the reel speed on the grain head will match the increased ground speed automatically. As one embodiment it is contemplated to incorporate this feature with seeder system 14 to adjust the seed rate automatically as the combine is operated at various speeds across the field to keep the seeding rate consistent. In the pictured example of FIG. 6 the hydraulic motor has a 14 tooth sprocket which uses a chain to drive a Trimble Tru count corn planter clutch which turns augers on and off depending on whether the corn head is in an up or down position. There is a whisker switch mounted on the combine feeder housing to communicate with the planter clutch to let augers run while the head is down to thereby not double spread the seed. The clutch is wired to a whisker switch using 12-volt power from the combine and a switch is in the combine cab to shut the augers off if the need arises. There is a hex shaft that runs through the clutch that connects to round DOM (drawn over mandrel) tubing that connects to both augers.

The grain head 12 cover crop seeder 14 is very similar to the corn head cover crop seeder except it may use a ground driven system 26, instead of being hydraulically driven.

The ground drive feature consists of a spiked Martin row cleaner wheel engaged by the turning due to engagement with the soil and then a gage wheel right next to it to limit the spike depth. The spiked Martin wheel is attached to a floating piece of rectangular steel tubing that is rotating to float across uneven ground so it doesn't skip which might result in no seed being spread. It is important to note, that the steel rectangular tubing is designed so when the grain head is being transported on a cart it is pinned up for safety and convenience.

In the example illustrated there are sprockets and number forty chains that go up to the top of the backside of the grain head 12. There is a hex shaft with approximately forty inter changeable Kinze planter sprocket combinations to set the exact rate needed for various cover crop species. It is also contemplated for the system 10 to be under the control of a controller 50 to adjust the movement of the elements of metering system 20 and distribution system 18 to consistently distribute the seed to the ground.

The grain head 12 has two dry fertilizer planter boxes 16 mounted on the left and right side to serve as seed boxes 16. The driven sprocket, located on the left side of the grain head, goes through the left seed box to drive the auger inside the box which functions to move a controlled rate of seed.

There is a DOM pipe connecting left seed box to the right seed box auger so one drive unit is only needed. The seed is augured out, both left and right sides of the grain head, through horizontal PVC piping, dropping it on two spread fans 24 powered by two 12-volt motors. The seed is spread behind the grain head 12 and in front of the combine tires 104.

The present invention advantageously spreads the seed immediately after the harvesting and prior to the distribution of the material other than grain (MOG) that leaves the back end of the combine 100 to provide a mulch or moisture retaining cover for the seed to enhance the germination and growth of the seeds.

Combine 100 has a chassis 102 carried by wheels 104 and 106. Combine 100 moves in an operational direction 108 while harvesting with header 12 (coupled to chassis 102) cutting the crop material and seeding system 14 distributing or broadcasting seed S on ground G generally behind and/or under header 12. As can be seen in the figures seeding system 14 is generally coupled to the back and top of header 12 with most of the mechanisms being to the outside portions of header 12. Seeding system 14 is configured to distribute seed S across the width of header 12. As mentioned above seeding system 14 includes a seed box 16 and distribution system 18 on each side of header 12 so that seed S is substantially uniformly delivered on ground G across the width of header 12.

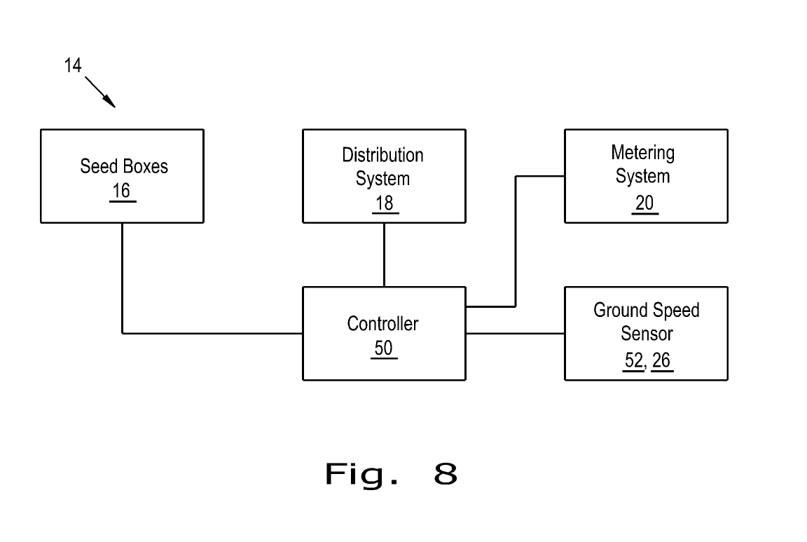

The seeding system 14 can have a controller 50 (see FIG. 8), which may be a controller that is integral with combine 100, to control seeding system 14 and to coordinate its action with the action of combine 100. Controller 50 controls the movement of the augers in seed boxes 16 based on input from metering system 20 to ensure uniform seeding. Controller 50 activates and controls the speed of fan 24 of distribution system 18 to correspond with harvesting taking place, which can be determined by other sensors, not specifically shown, on combine 100. Controller 50 instructs metering system 20 to cause seeds to enter distribution system 18 dependent upon seed type, and the ground speed combine 100. The ground speed can be determined by the speed detector 26 discussed above or by another speed sensor 52, which may be a GPS system or other sensor on combine 100. It is also contemplated that controller 50 will modify the distribution of seeds by its interaction with the elements of seeding system 14 when combine 100 is traversing already harvested and seeded ground to avoid multiple coverage.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural harvester, comprising:
a chassis;
a header coupled to the chassis; and
a seeding system coupled to one of the chassis and the header, the seeding system being configured to broadcast seed onto the ground as the harvester traverses the ground.

2. The agricultural harvester of claim 1, wherein the seeding system is coupled to the header.

3. The agricultural harvester of claim 2, wherein the seeding system is primarily coupled to a top and backside of the header.

4. The agricultural harvester of claim 3, wherein the seeding system is configured to distribute seed behind the header as the harvester proceeds in an operational direction.

5. The agricultural harvester of claim 1, wherein the seeding system includes:
a seed metering system; and
a seed distribution system coupled to the seed metering system.

6. The agricultural harvester of claim 5, wherein the seed distribution system includes a fan to distribute seeds.

7. The agricultural harvester of claim 6, wherein the seeding system uses a ground speed of the harvester to determine the flow of seeds from the seed metering system to the seed distribution system.

8. The agricultural harvester of claim 1, wherein the seeding system is configured to distribute seeds to the ground after crop material is cut and before material other than grain is distributed onto the ground.

9. A header/seeder system for use by an agricultural harvester, comprising:
a header; and
a seeding system coupled to the header, the seeding system being configured to broadcast seed onto the ground as the harvester traverses the ground.

10. The header/seeder system of claim 9, wherein the seeding system is primarily coupled to a top and backside of the header.

11. The header/seeder system of claim 10, wherein the seeding system is configured to distribute seed behind the header as the harvester proceeds in an operational direction.

12. The header/seeder system of claim 9, wherein the seeding system includes:
a seed metering system; and
a seed distribution system coupled to the seed metering system.

13. The header/seeder system of claim 12, wherein the seed distribution system includes a fan to distribute seeds.

14. The header/seeder system of claim 13, wherein the seeding system uses a ground speed of the harvester to determine the flow of seeds from the seed metering system to the seed distribution system.

15. The header/seeder system of claim 9, wherein the seeding system is configured to distribute seeds to the ground after crop material is cut and before material other than grain is distributed onto the ground by the harvester.

16. A method of seeding a cover crop, comprising the steps of:
cutting a crop using an agricultural harvester; and
distributing seed from a seed tank coupled to the agricultural harvester onto the ground.

17. The method of claim 16, further comprising the step of metering the seed from the seed tank dependent upon a ground speed of the agricultural harvester prior to the distributing step.

18. The method of claim 17, wherein the metering step uses a seed metering system to meter the seed, and the distributing step uses a seed distribution system coupled to the seed metering system to distribute the seed.

19. The method of claim 18, wherein the seed distribution system includes a fan to distribute seeds.

20. The method of claim 18, further comprising the step of using a ground speed of the agricultural harvester to determine an amount of seed to meter in the metering step, the distributing step distributing the seed to the ground after crop material is cut and before material other than grain is distributed onto the ground by the harvester.
